(19) United States
(12) Patent Application Publication
(10) Pub. No.: US 2005/0219756 A1
(43) Pub. Date: Oct. 6, 2005

(54) Thin film magnetic recording head and sub-mount

(76) Inventors: Matthew P. Dugas, St. Paul, MN (US); Gregory L. Wagner, Arden Hills, MN (US)

Correspondence Address: Devan V. Padmanabhan;DORSEY & WHITNEY LLP, Intellectual Property Department, 50 South Sixth Street, Suite 1500, Minneapolis, MN, 55402-1498, US

(21) Appl. No.: 11/017,106

(22) Filed: Dec. 19, 2004

Related U.S. Application Data
(60) Provisional application No. 60/531,417, filed on Dec. 19, 2003.

(51) Int. Cl. G11B 5/48

(52) U.S. Cl. 360/241

(57) ABSTRACT

A magnetic recording head assembly, and method, for connecting a magnetic head within a magnetic tape device such as a tape formatting device. In one example, the assembly includes a mounting device for attachment to the magnetic tape device, and a sub-mount for attaching the magnetic head to the mounting device, the sub-mount having a first end connected with the magnetic head and a second end removably connected with the mounting device. By attaching the head to one end of the sub-mount, the head/sub-mount combination can be removably attached to the mounting device which is (or will be) attached to the magnetic tape device. The sub-mount and mounting device provide an improved level of flexibility for connecting heads to various different magnetic tape devices. Various embodiments of the invention are disclosed.

### CROSS REFERENCE TO RELATED APPLICATION

This application claims the benefit under 35 U.S.C. § 119(e) of U.S. Provisional Patent Application No. 60/531,417 entitled “Thin Film Magnetic Recording Head and Sub Mount” filed on Dec. 19, 2003, the disclosure of which is hereby incorporated by reference in its entirety.

### TECHNICAL FIELD

The present invention relates generally to magnetic recording heads, such as those made of thin-film materials and ceramic materials. In particular, the present invention relates to methods and apparatuses used in writing servo tracks onto a tape surface during production of tape.

### BACKGROUND

Magnetic tape as a data storage medium requires the ability to effectively write and read data to data tracks of the magnetic tape. Many such data tracks typically extend linearly along the length tape and, in part, define tape density. In addition, for providing a controlled movement of tape reading and/or writing heads with respect to the data tape, servo tracks are commonly used which also extend linearly along the length of tape. Servo tracks are typically written in such a way as to span the tape in an efficient manner that maximizes the number of data tracks and minimizes the number of servo tracks for a given tape system. Data reading and writing heads thus typically also include one or more servo read heads. Servo read heads may either be specifically dedicated servo reads heads or they may be data read heads that are operating as servo read heads at a particular track position.

Such read and write heads are normally supported within a structure that is part of the tape guiding system. A tape guiding system may include one or more tape bearing surfaces that guide and space the moving tape relative to the head for effective data storage (reading and/or writing). Such tape bearing surfaces and related structures can be made in many different ways and have different designs depending on the storage tape utilized, its operational parameters, and other storage device design aspects. With many storage tape systems and manufacturers, many different tape storage mechanisms and tape bearing structures have been developed.

Servo write and servo verification heads, contained in a carrier device, are precisely mounted into tape path structures that are contained on systems specially designed to accurately write and verify the servo patterns. Such systems, containing the tape path and a tape deck for mounting the elements of the tape path, are precisely controlled to achieve the stringent requirements of the tape data storage system.

As recognized by the present inventors, it is desirable on such systems to minimize the amount of mechanical adjustments and modifications to the system in the production environment. These modifications may result from the exchange of servo read and write heads as they wear out, or the inclusion of new servo read or write heads as the technology evolves. Also, as technology evolves, the dimensions for a carrier device may vary from the dimensions used in the testing environment.

To ensure proper quality control, servo heads must be tested prior to servo writing production operations. In short, they undergo operational testing for the electrical signature of the servo pattern, as well as the correct placement of that servo pattern onto the tape. During testing, the heads are mounted to a test system with a certain high degree of precision. Once this has been done, as recognized by the present inventors, it would be ineffective and impractical to entirely remove the head from its carrier or mounting device as the specific location of the head in the tape path structure is part of the test qualification and, as such, that operation would have to be repeated upon a factory installation.

FIGS. 1 and 2 illustrate an example of a conventional prior art head 1 and head mounting device 2. The head 1 is permanently attached to the head mounting device 2. This combination may be designed for incorporation within a tape bearing structure of a data storage system or for use in a production environment.

The head, or specific structures within the head, is generally spatially located in the tape path. This location is generally controlled by the three translation axes (X, Y, Z) and the three principle rotations around these translation axes (FIGS. 1 and 2), or six dimensions in all. In general, the mating of a plane to a reference surface will restrict one translation axis and two rotation axes. The mating of a single round pin to a bored hole may restrict two translation axis. The mating of a round pin to a slot may restrict one translation axis. For pins to restrict rotation axis, two or more pins, spatially separated, can be utilized.

In FIGS. 1 and 2, mounting device 2 has a precision ground surface 7 that serves as the reference surface. This reference surface mounts flush to the reference surface of the tape deck. Additionally the head mounting device 2 may have precision pin recesses 5 and 6 which mate to pins on the tape deck surface. Such a system places the head mounting device 2 precisely upon the tape deck properly. The above discussion is a typical prior art example of locating and fixing a precision head mounting device onto a tape deck. As is also well known in the art, the guided magnetic tape edge is also referenced from the tape deck plane and its tape path is controlled to present the tape to the mounted recording head to a high degree of precision.

In accurate positioning of the head 1 to the mounting device 2, many different spatial relationships are preferably considered. Tape penetration or wrap angle can be set by the distance of A shown in FIG. 1. Head height is shown as B in FIG. 2 as the distance from a reference surface (side surface 7) to a head feature or track (such as the first head element 3). The head 1 itself is also preferably oriented properly with respect to its pitch, roll and azimuth. The head pitch is the rotational position of the head 1 about axis X, head roll is the rotational position of the head 1 about axis Y, and the azimuth is determined by the position of the head 1 about the axis Z. These spatial relationships are typically considered in the designing of a combination head 1 and mounting device 2 as part of a tape guiding structure of a data storage mechanism.

In such a precision mounting scheme, head 1 can be aligned accurately to the mounting device 2 so that when the combination is located and fixed to the tape deck, the relevant head gap features are accurately aligned with the magnetic tape and its moving tape path.

Mounting device 2 itself is designed to accurately fit within the tape bearing structure or tape deck so that the tape will move properly through the data storage device. In one such structure, a pair of spaced pins (not shown) can be utilized that are themselves accurately located to the data storage device structure. One such pin can engage in a first pin-shaped recess 5 provided in a side face of the mounting device 2 and an other pin may engage with a slotted recess 6 spaced from recess 5. The pin-shaped recess 5 positions the mounting device 2 accurately on a first pin and the slotted recess 6 controls the rotational position of the mounting device 2 with respect to the first pin. As such, the mounting device 2 can be accurately positioned within a data storage device mechanism such as a tape deck.

As above, the mounting device 2 is positioned accurately based upon the engagement of recesses 5 and 6 with precisely located pins (not shown) and the accurate position of the head 1 can include the special relationships including tape penetration, head height, head pitch, head roll and head azimuth. For any given data storage device, such special relationships may be specified. Thus, for a head 1, accurate positioning depends largely on the support surface 8 of the mounting device 2 and the manner by which they are attached to one another.

In the case where adhesive is used to attach the head 1 to the support surface 8, the adhesive layer itself may entirely determine such spatial relationships when it cures as setting the head 1 in proper place with respect to the support surface 8.

Positioning and alignment of the head 1 on the mounting device 2 may be based on a relationship of the support surface 8 to the surface 7 and the precision of recesses 5 and 6 (each surface is provided by precision machining or grinding) and the temporary seating surface 7 on a head alignment jig. Then, using accurately controlled grippers, the head 1 can be grasped from below through an opening 10 for positioning the head 1 accurately with respect to each of the above noted spatial relationships. That is, the head 1 can be held just above support surface 8 exactly as desired based upon predetermined specifications, which positioning may be determined based upon feedback of the gripping mechanism or by any position monitoring or sensing devices that read one or more surface positions of the head 1. The position of the mounting device 2 may be set by the surface 7 and seating recesses 5 and 6 in the jig, which position may also be monitored. Then, a liquid adhesive can be applied between the lower surface of the head 1 and the support surface 8 of the mounting device 2 and the head 1 can be held in accurate position until the adhesive is sufficiently cured to thereafter retain the head 1 accurately with respect to the mounting device 2. Hence the head 1 is precision mounted to device 2 with respect to the references used to attach the device to the tape deck.

Hence the servo track features written upon the tape will be accurately written upon the tape by the control of parameters such as: distance from edge of tape, azimuth angle of pattern onto the tape, head penetration into the tape, tape tension as determined by the head contour, tape path over the head, and so on. In other words, the mounting device 2 is placed and fixed precisely upon the tape deck and the head device 1 is placed and fixed precisely upon the mounting device 2.

With the head 1 accurately positioned with respect to the mounting device 2 and the recesses 5 and 6 of the mounting device 2 accurately provided for mounting to pins (not shown) of an tape bearing structure of a data storage device, any head 1 can be precisely located on any mounting device 2 for use by a data storage device manufacturer in making such data storage devices and systems. As noted above, though, such manufacturers of data storage devices and systems may develop any number of ways to move tape through such a device and thus may develop any number of different tape bearing structures.

With the making of heads that are particularly suitable for servo heads, the heads may be mounted to such mounting devices where accurate positioning can be controlled. Moreover, mounting the heads to such devices before significant handling or shipping is beneficial due to the fragile nature of such heads.

Accordingly, providing heads to data storage device manufacturers can be complicated by the need to utilize specified mounting devices with any known or developed tape bearing structures on a user designed basis requiring the availability of any number of such mounting devices.

Also, as recognized by the present inventors, it is desirable to test the recording and reading ability of any such head prior to sending to a data storage device manufacturer, wherein such testing is preferably conducted in the same manner as the head is to be utilized by the data storage device manufacturer. Finally, some data storage device manufacturers have developed proprietary tape bearing paths that are not known by the head device manufacturer. Such proprietary tape bearing systems may have a need for a proprietary head mounting device 2. As recognized by the present inventors, the head device manufacturer should attempt to accommodate such data storage manufacturers in the most flexible manner possible but at the same time guarantee the integrity and safe handling of the head device 1.

It is against this background that various embodiments of the present invention were developed.

### SUMMARY

In light of the above and according to one broad aspect of one embodiment of the present invention, disclosed herein is a magnetic recording head assembly for connecting a magnetic head within a magnetic tape device, such as a tape formatting device for writing servo-tracks to a magnetic tape. In one example, the assembly includes a mounting device for attachment to the tape formatting device, the mounting device having a receiving cavity; and a sub-mount for attaching the magnetic head to the mounting device, the sub-mount having a first end connected with the magnetic head and a second end removably connected with the mounting device within the receiving cavity.

The mounting device may include a tape guiding structure for guiding a tape along the mounting device and over the magnetic head. In one example, the cavity of the mounting device may be generally U-shaped (cross-section), and the mounting device includes at least one bore hole for positioning the mounting device relative to the tape formatting device.

In another embodiment, the sub-mount may include at least one surface for mating with at least one surface of the mounting device. The at least one surface of the sub-mount may be a bottom surface and includes at least one pin receiving opening, and the at least one surface of the mounting device may be a top surface engaging the bottom surface of the sub-mount and includes at least one pin for engagement with the at least one pin receiving opening of the sub-mount. The sub-mount may have a central opening extending between the first end and the second end, as well as a recessed slot for housing a wire guide.

In one example, the magnetic head is attached to the sub-mount by an adhesive, and may be attached to the sub-mount at an offset from a center of the sub-mount, or centered relative to the sub-mount. The magnetic head can take many forms, such as a ferrite head, a thin film head, or any other conventional head.

According to another broad aspect of another embodiment of the present invention, disclosed herein is a method of mounting a head to a tape formatting device. In one example, the method includes the operations of providing a sub-mount; providing a mounting device; attaching the head to the sub-mount; and attaching the sub-mount to the mounting device. The method may also include attaching the mounting device to the tape formatting device.

In one example, the operation of attaching the head to the sub-mount may be performed in accordance with a predetermined spatial relationship.

According to another broad aspect of another embodiment of the present invention, disclosed herein is a magnetic tape manufactured by a method comprising writing servo information onto the magnetic tape using a servo head mounted on a sub-mount that is removably attached to a mounting device. In one example, the method includes attaching the sub-mount to the mounting device along a plane of the sub-mount. The attaching operation may include providing, on the plane of the sub-mount, at least one a hole, pin, or other attachment mechanism.

According to another broad aspect of another embodiment of the present invention, disclosed herein is an apparatus for coupling a magnetic head to a mounting device of a tape formatting device. In one example, the apparatus includes an elongated body having a first end for connection with the magnetic head and a second end for removable connection with the mounting device. The elongated body may include at least one surface for mating with at least one surface of the mounting device, wherein the at least one surface of the elongated body may be a bottom surface that includes at least one pin receiving opening. The at least one surface of the mounting device may be a top surface engaging the bottom surface of the elongated body that includes at least one pin for engagement with the at least one pin receiving opening. The elongated body can have a central opening extending between the first end and the second end.

In one example, the elongated body has a recessed slot for housing a wire guide, and the magnetic head may be attached to the elongated body by an adhesive either at a centered position relative to an end of the elongate body or at an offset from a center position.

According to another broad aspect of another embodiment of the present invention, disclosed herein is a tape formatting device. In one example, the tape formatting device includes a magnetic head; a mounting device for attachment to the tape formatting device, the mounting device having a receiving cavity; and a sub-mount for attaching the magnetic head to the mounting device, the sub-mount having a first end connected with the magnetic head and a second end removably connected with the mounting device.

In one example of the invention, testing of a servo head in a given tape path configuration can be conducted prior to production (for instance, in an outgoing quality assurance test at the head manufacture laboratory) and then transferring this tested head to a production setting and onto a customer specific tape path configuration.

In another example, a completely unique production tape path can be formed apart from that of the head test tape path. A reference can be established by a sub-mount attached to a head and can be transferred—which allows the head to be easily utilized in two separate tape paths in a unique manner that satisfies the dual purpose of a servo head test in one tape path, and then servo writer production in yet another tape path, without realignment of the head itself. Other similar dual site head testing could be realized with embodiments of the present invention.

The foregoing and other features, utilities and advantages of the invention will be apparent from the following more particular description of various embodiments of the invention as illustrated in the accompanying drawings and claims.

### DESCRIPTION OF THE DRAWINGS

FIG. 1 illustrates an end view of a conventional magnetic recording head and head mounting device.

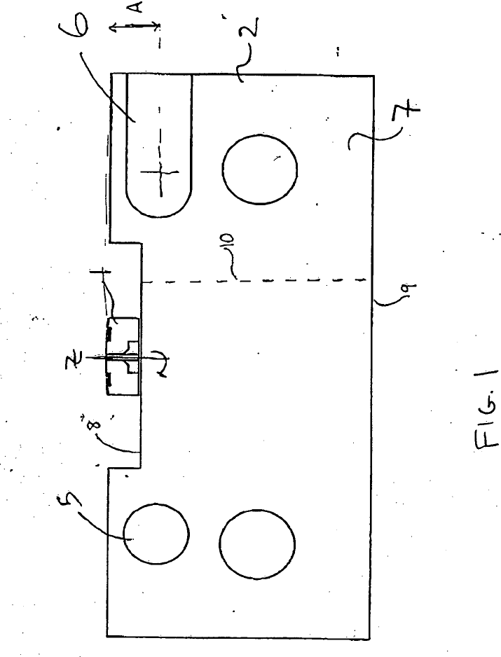

FIG. 2 illustrates a front view of a conventional magnetic recording head and head mounting device of FIG. 1.

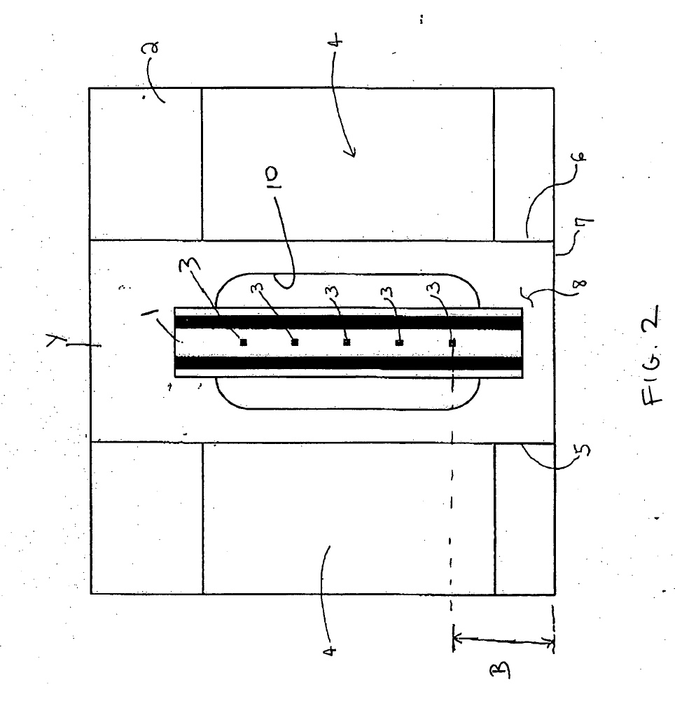

FIG. 3 illustrates an end view of a magnetic recording head, sub-mount and head mounting device, in accordance with one embodiment of the present invention.

FIG. 4 illustrates a front view of the assembly of FIG. 3, in accordance with one embodiment of the present invention.

FIG. 5 illustrates a side view of the assembly of FIG. 3, in accordance with one embodiment of the present invention.

FIG. 6 illustrates a bottom view of the assembly of FIG. 3, in accordance with one embodiment of the present invention.

FIG. 7 illustrates an exploded view of a magnetic recording head, sub-mount and head mounting device of FIG. 3, in accordance with one embodiment of the present invention.

FIG. 8 illustrates an isometric view of a magnetic recording head/sub-mount and first and second mounting devices, in accordance with one embodiment of the present invention.

FIG. 9 illustrates the recording head/sub-mount of FIG. 8 positioned within the first mounting device, in accordance with one embodiment of the present invention.

FIG. 10 illustrates the recording head/sub-mount of FIG. 8 positioned within the second mounting device, in accordance with one embodiment of the present invention.

FIG. 11 illustrates an isometric view of a magnetic recording head and sub-mount having a cover, in accordance with one embodiment of the present invention.

FIG. 12 illustrates an isometric view of a magnetic recording head and sub-mount of FIG. 11, in accordance with one embodiment of the present invention.

FIG. 13 illustrates another isometric view of a magnetic recording head and sub-mount of FIG. 11, in accordance with one embodiment of the present invention.

FIG. 14 illustrates an isometric view of a magnetic recording head and another sub-mount, in accordance with one embodiment of the present invention.

FIG. 15 illustrates an example of operations for attaching a head to a tape formatting device, in accordance with one embodiment of the present invention.

### DETAILED DESCRIPTION

Disclosed herein is a magnetic recording head assembly, and method, for connecting a magnetic head within a magnetic tape device, such as for example but not limited to, a tape formatting device/system that writes servo tracks on a magnetic tape. In one example, the assembly includes a mounting device for attachment to the tape formatting device, and a sub-mount for attaching the magnetic head to the mounting device, the sub-mount having a first end connected with the magnetic head and a second end removably connected with the mounting device. By attaching the head to one end of the sub-mount, the head/sub-mount combination can be removably attached to the mounting device which is (or will be) attached to the tape formatting device. The sub-mount and mounting device provide an improved level of flexibility for connecting heads to various different tape formatting devices. Various embodiments of the invention are described herein.

Generally and in one example, a sub-mount has a generally elongated body structure having a top surface and a bottom surface with a central opening/cavity extending therebetween. The top surface is adapted to be secured with a head, and the bottom surface is adapted to be removably secured to a surface of a mounting device. The bottom surface may include a recessed slot for housing a wire guide so that wires can be routed from the bottom of the sub-mount to the head fixed to the top surface of the sub-mount. The bottom surface of the sub-mount may include one or more openings for receiving pins or bolts for positioning and securing the sub-mount to the mounting device.

A mounting device includes a mating surface adapted to mate with the bottom surface of the sub-mount. The mounting device may include a cavity defined by the mating surface and one or more side walls. The mating surface may include one or more openings to provide for pins, bolts, posts or other conventional alignment structures to align the sub-mount relative to the mounting device. The mounting device may also include recesses, bore holes, slotted recesses or other conventional structures to secure and align the mounting device to the tape storage device.

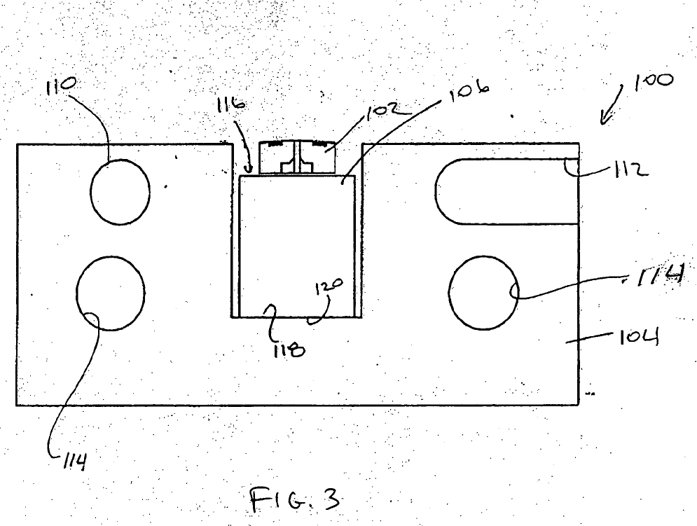

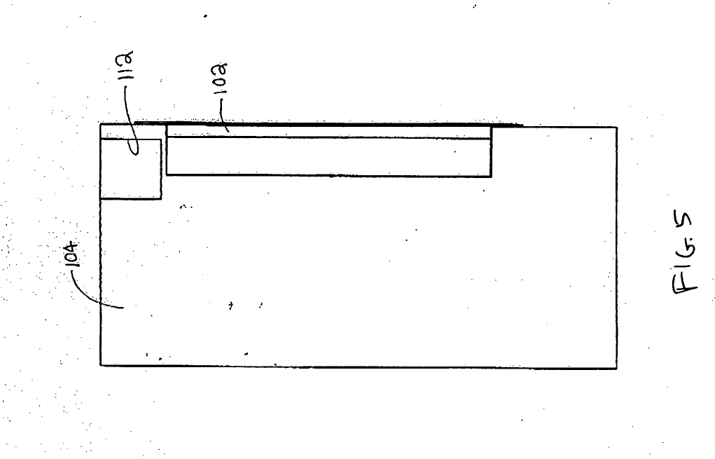

With reference to FIGS. 3-15, various examples of combining a head with a mounting device by way of a sub-mount are illustrated, in accordance with embodiments of the present invention. Such constructions are advantageous in that a head can be combined with a sub-mount, which sub-mount need not have the specific characteristics required of a mounting device as such is utilized for guiding data recording tape. Moreover, the head and sub-mount assembly can be accurately aligned with respect one another so that the sub-mount can be precisely connected with the mounting device to provide an accurately aligned head and mount assembly for use in a tape guiding structure. By controlling certain precision surfaces of the sub-mount and mounting device, accurate alignment can be effected. Furthermore, the use of a submount permits a head manufacturer to combine a fragile thin film magnetic head with a sub-mount assembly to be shipped to a data storage device manufacturer. Then, the head and sub-mount assembly can be combined with the mounting device having specific tape guiding structure required by the manufacturer. A head manufacturer would also no longer need to combine the heads with specific mounting devices for each different data storage device manufacturer.

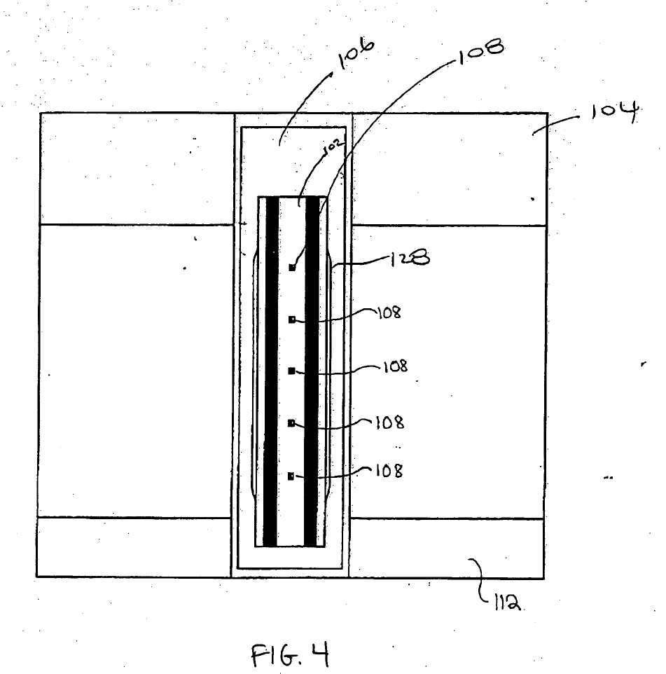

In FIGS. 3-7, a device or assembly 100 is shown. A head 102 is connected with a mounting device 104 by way of a sub-mount 106. The structure of the head 102 and the mounting features of the mounting device 104 may be similar to those described above, or may incorporate any known constructions. In the illustrated example, the head 102 is shown provided with five head elements 108 (FIG. 4) set out as would be usable in an example of servo head construction. The manner of making the head 102 can be by any known or conventional technique.

In one example, the mounting device 104 is illustrated as having a precision recess 110 for engaging with a precision pin (not shown) for mounting the assembly 100 in a precision manner. Likewise, a precision slotted recess 112 is shown for locking the rotation of the assembly 100 as also described above. Bore holes 114 are also provided through the mounting device 104 to facilitate screws or bolts also used for mounting the assembly 100, preferably after the recesses 110 and 112 are used with the precision pins (not shown) for alignment of the assembly 100. That is, the screws or bolts through the bores 114 may be used to secure the combination 100 in place as aligned by the cooperation of precision recesses 110 and 112 with the precisely aligned pins (not shown).

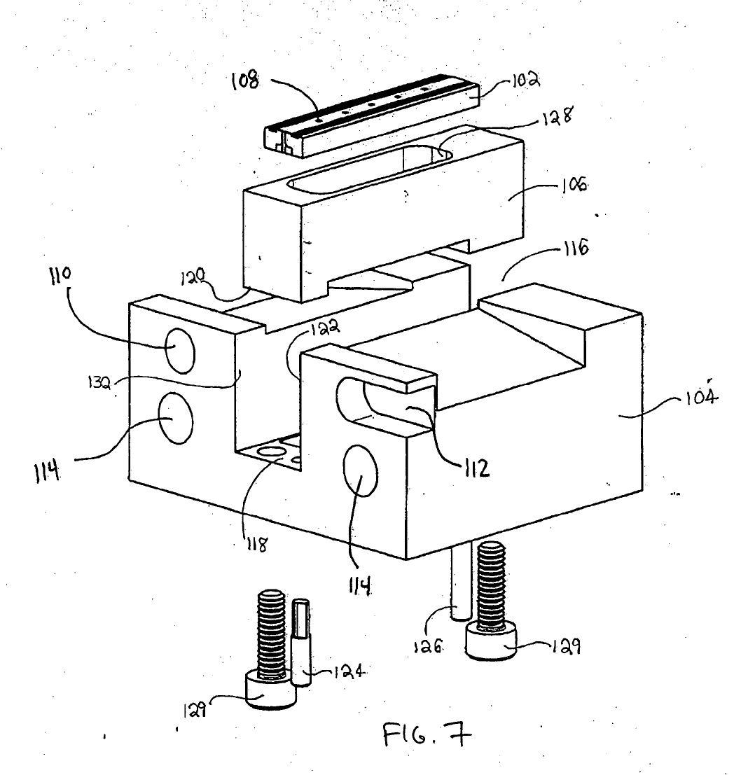

In accordance with an embodiment of the present invention, the mounting device 104 includes a cooperating structure for receiving the sub-mount 106. preferably, a receiving space or cavity 116 is provided which includes one or more precision surfaces to receive at least one precision surface of the sub-mount 106. The receiving cavity 116 can take various shapes to receive the sub-mount 106 and will depend upon the particular implementation of the sub-mount 106. In one example, the cavity 116 has a generally U-shaped cross-section (FIGS. 3, 7) and in another example the cross-section may be generally L-shaped.

As shown in FIG. 7, the mounting device 104 includes a pair of spaced top surfaces 118 (only one of which is visible in FIG. 7) for precise engagement with a bottom surface 120 of the sub-mount 106. It is preferable that both surfaces 118 and are machined or ground in a known predetermined relationship with respect one another so that a head 102, when accurately aligned to the sub-mount 106, will be accurately aligned to the mounting device 104 with respect to at least the penetration depth of the head 102. Receiving space 116 is also shown bounded by side surfaces 132 and 122 of the mounting device 104, and these side surfaces 122, 132 may be utilized, but need not be, as part of the precise alignment process. Mounting device 104 may include any conventional attachment means for attaching mounting device 104 to a tape formatting device, and can be aligned or orientated with respect to the tape formatting device in any conventional manner (i.e., as described above).

Preferably, a cooperating pin and recess structure may be utilized between the sub-mount 106 and the mounting device 104 for precision alignment. It is contemplated that any conventional cooperating structure may be utilized for this purpose, preferably where at least one surface of the sub-mount 106 or a surface precisely connected thereto accurately engages a precision surface of the mounting device 104 or a surface precisely connected thereto. In one example, a first pin 124 is accurately supported to extend from the top surface 118 of the mounting device 104 and a second pin 126 is accurately supported to extend from the other spaced top surface 118 of the mounting device 104. The sub-mount 106 likewise preferably includes pin receiving openings or bores (not shown) on the bottom surface 120 precisely machined to receive the pin structures of pins 124 and 126. As shown in FIG. 7, one of the pins, such as pin 124, preferably is noncircularly shaped, such as diamond or hexagonal shaped, or the like, to minimize possible binding issues from tolerance stack up. Any conventional method of precisely machining the relevant surfaces of the pins 124 and 126 and the pin receiving openings of the sub-mount 106 can be used.

The side surfaces 132 and 122 of the mounting device 104 could be utilized for precise side-to-side positioning of the sub-mount 106 within receiving cavity 116. A further precise structure could also be used for positioning the sub-mount 106 in the third dimension (i.e., extending into the sheet as shown in FIG. 3), although may restrict the rotational constraints and increase the necessary machining tolerances. The use of pins 124 and 126 along with precision alignment of surfaces 118 and 120 in the example of FIG. 7 is sufficient for accurate positioning of the sub-mount 106 with respect to the mounting device 104. Mounting bolts 129 can be used to secure the sub-mount to the mounting device.

Thus, it can be seen in that accurate positioning of the head 102 with respect to the sub-mount 106 can be effectively translated to the assembly 100 by mounting the sub-mount 106 to the mounting device 104. In the example of FIGS. 3-7, the sub-mount 106 includes a precision bottom surface 120 and a plurality of precision pin receiving openings (not shown). In one example, the mounting device 104 includes a precision top surface 118 and precision pins 124 and 126, at least one of the pins preferably includes a nonbinding shaped structure for ease in assembly and to limit rotary motion of the sub-mount 106 within the receiving cavity 116.

In general, a configuration which provides for precise alignment in all six dimensions is preferred. In one embodiment of the invention, one plane is used for reference and is shown in FIG. 7 as defined by surfaces 118/120. In this example, all faces and pins or holes used for reference transfer are contained on the same machining process plane, as this simplifies manufacturing.

The head 102 can be aligned with respect to sub-mount 106 as follows. The sub-mount 106 can be precisely positioned within a jig (not shown) and the head 102 can be oriented and held in position by one or more gripping devices (not shown) by way of access provided through a central opening 128 (FIGS. 4, 7) of the sub-mount 106. Any conventional technique for sensing the position of the head 102 with respect to the sub-mount 106 can be utilized, such as sensing one or more surfaces of the head 102 directly or indirectly, and/or by monitoring the position of grippers. Once the head 102 is accurately positioned with respect to the sub-mount 106, adhesive may be provided between relevant surfaces so that when cured, the adhesive secures the head 102 in precise location with respect to the sub-mount 106. Such positioning of the head 102 with respect to the sub-mount 106 may include consideration of the spatial relationships with respect to tape penetration, head height, azimuth, pitch and roll or other dimension or characteristic. Once the head 108 has been secured to sub-mount 106, each of the spatial relations are thus translated to the assembly 100 by the precise connection of sub-mount 106 to the mounting device 104.

Because the mounting device 104 is not directly connected with the head 102, a data storage device manufacturer can combine a head 102 with a mounting device 104 in a reliable and precise manner through the use of sub-mount 106. Thus, as different manufacturers use different mounting devices 104, such as having differently designed tape guiding surfaces or other structures, a similar head 102 and sub-mount 106 can be usable with different mounting devices 104. As such, a manufacturer of multiple data storage devices can interchange or selectively mount a combined head 102/sub-mount 106 to various different mounting devices 104, as may be appropriate for different data storage tape products.

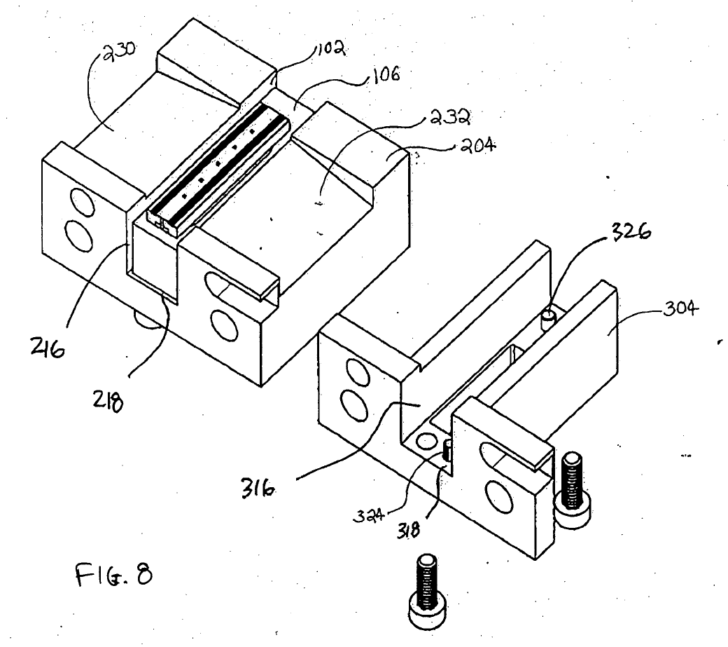

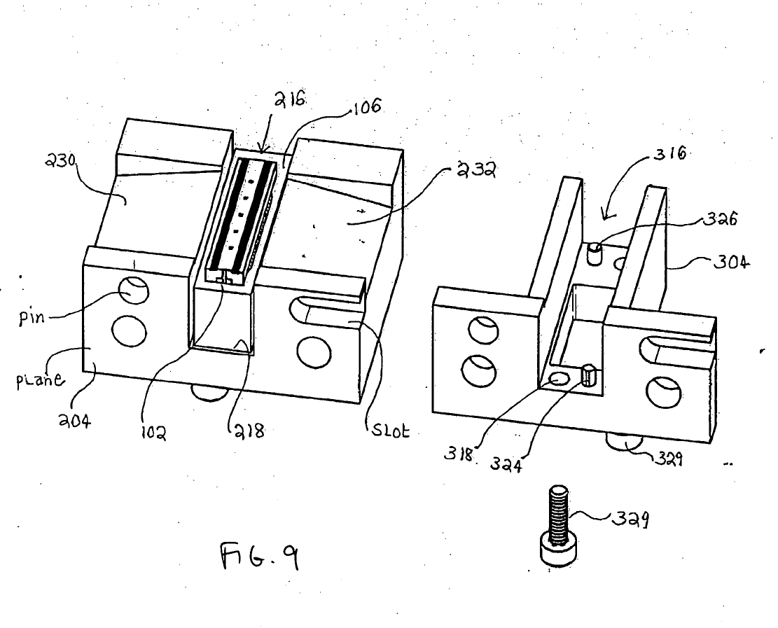

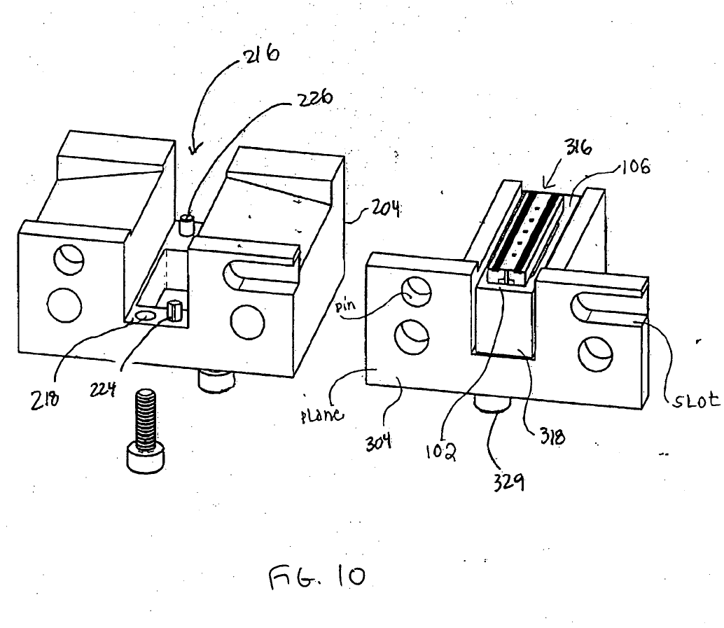

For example, as shown in FIGS. 8-10, the assembly of a head 102 fixed to a sub-mount 106 can be interchanged between a mounting device 204 and another mounting device 304. FIGS. 8-9 show the head 102/sub-mount 106 connected with and positioned in mounting device 204, and FIG. 10 shows the same head 102/sub-mount 106 connected with and positioned in mounting device 304.

Both mounting devices 204 and 304 preferably include similar precision surfaces 218, 318, such as described above, for accurately positioning the sub-mount 106 within receiving spaces 216 and 316. In FIGS. 8-9 as to mounting device 304, a top surface 318 is shown around and between precision pins 324 and 326 so that the sub-mount 106 may be precisely located within receiving space 316. Similarly, mounting device 204 in FIG. 10 has a top surface 218 and first and second pins 224, 226 for accurately receiving the sub-mount 106.

In FIG. 8, mounting device 204 has downwardly angled surfaces 230, 232 that provide a specific recording tape path for head 102 such that mounting device 204 is a functional part of the data storage device. Mounting device 304, however, has no specific tape guiding structure or geometry in this example. Mounting device 304 can be further provided with any designed or developed other structure as may be utilized for tape guiding or bearing functionality. Due to its smaller size/volume, device 304 reduces the amount of space on the tape deck needed for its incorporation, thus allowing cross compatibility between tape paths with differing spatial constraints.

In use, the head 102 and sub-mount 106 can be independently tested within one or more mounting devices, such as mounting devices 204 or 304, before they are shipped to a data storage device manufacturer or by a data storage device manufacturer. Prior to shipping a head 102 with a sub-mount 106, the head 102 can be tested for basic record and read functions. The head 102 and mounting device assembly 100 could be tested as it would be shipped and used by the data storage device manufacturer. In accordance with an embodiment of the present invention, such testing could be done with a head 102 combined with a sub-mount 106, and/or in a way as it would be used with a moving tape. Thus, the head 102 and sub-mount 106 can be mounted in any mounting device, such as mounting device 204 of FIG. 9, as long as it includes a proper receiving space 216 adapted for the particular sub-mount 106. Proper performance can be tested prior to shipping even though the expected use of the head 102 and sub-mount 106 within an entirely different mounting device, such as 304.

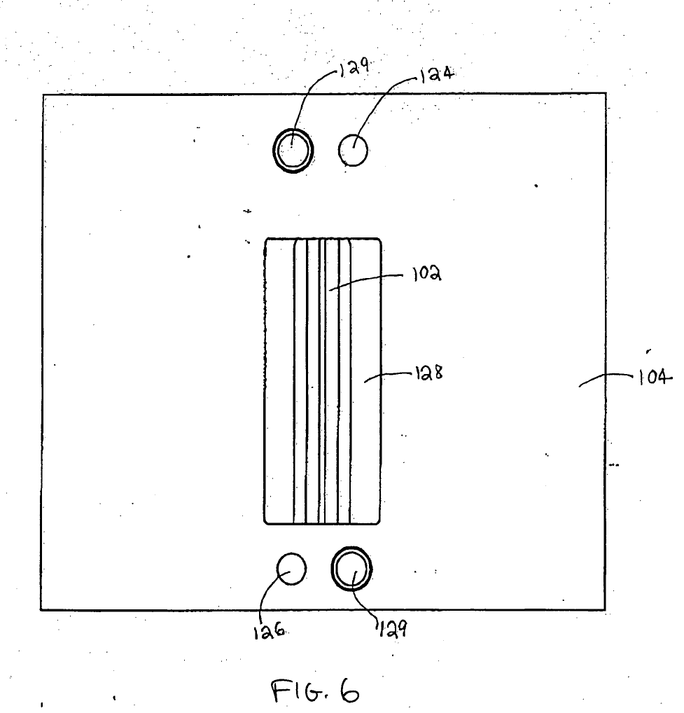

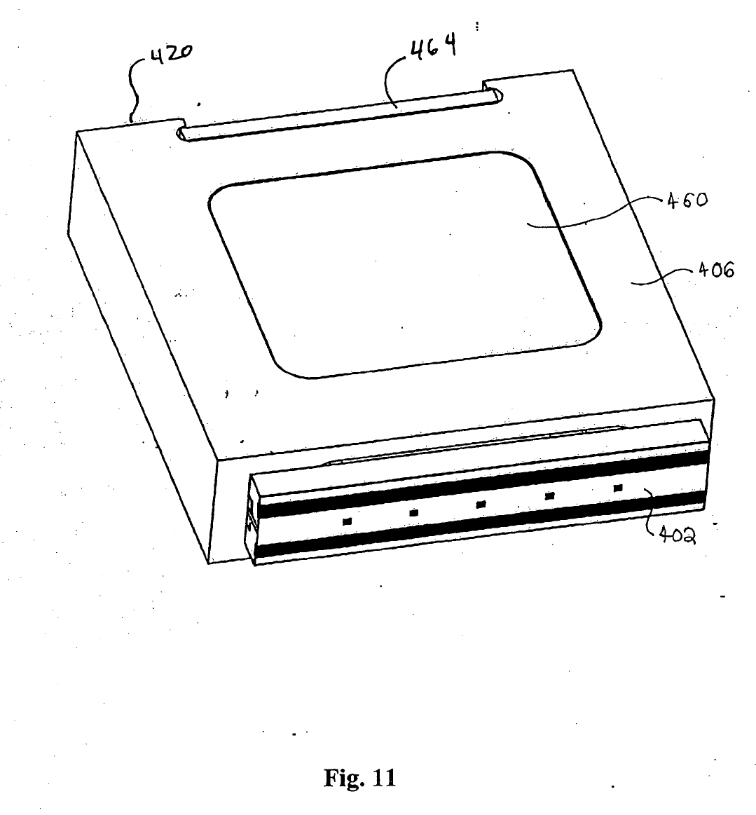

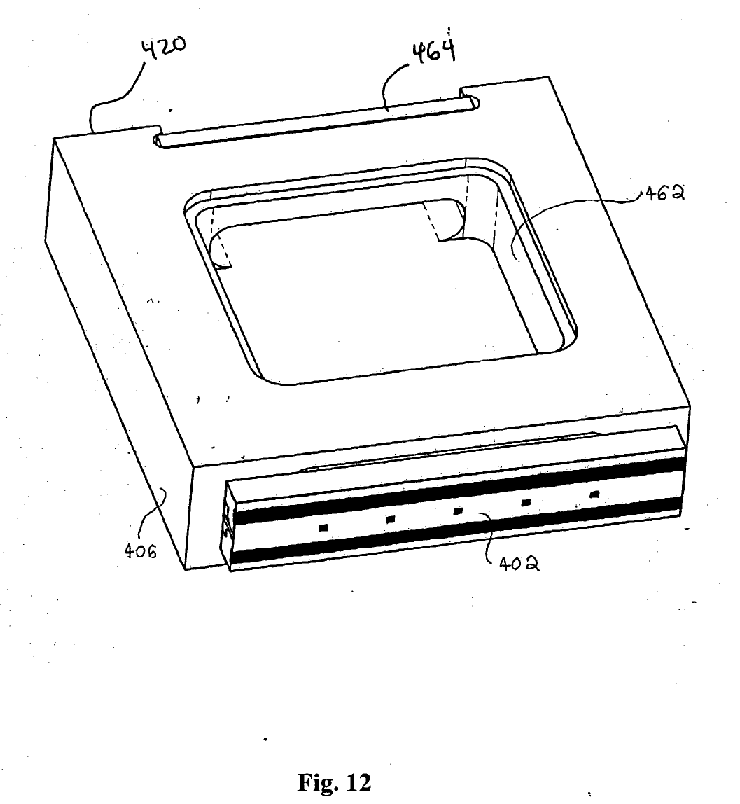

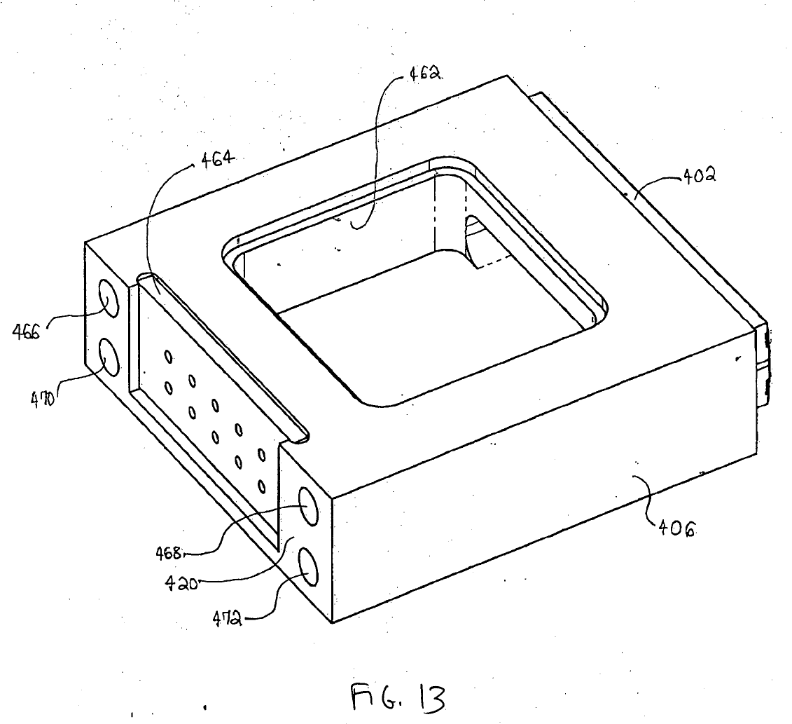

FIGS. 11-13 show a head 402 connected with another example of a sub-mount 406 as may be provided for a specific application. The sub-mount 406 may have an opening or interior space 462 (FIGS. 12-13). In FIG. 11, a cover 460 is illustrated for enclosing the interior space 462. The interior space 462 provides electrical connectivity space between the head 402 and a wire guide 464 (FIG. 13) shown recessed within the bottom surface 420 of the sub-mount 406. Precision bottom surface 420 (FIG. 13) includes first and second precision openings 466 and 468 that are sized and shaped for precise engagement with precision pins, such as pins 124 and 126 in FIG. 7, described above. Next to each of the precision openings 466 and 468, mounting holes 470 and 472 are also provided for receiving mounting bolts or screws, such as 129 as shown in FIGS. 6-7 (in one example, only one bolt for each side is utilized in FIG. 13).

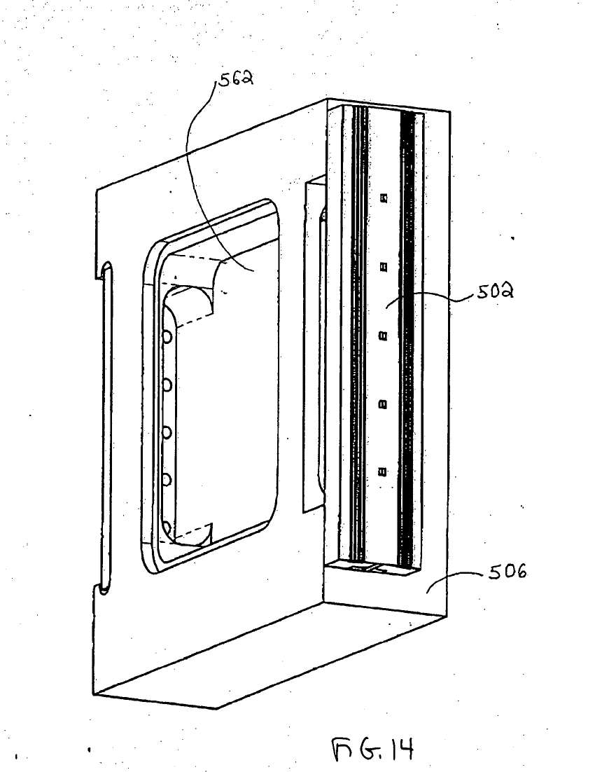

FIG. 14 illustrates another example of a head 502 and sub-mount 506 within interior space 562, wherein head 502 is secured at an offset from a central position with respect to a top surface 508 of the sub-mount 506, as compared to the sub-mount 406 and head 402 of FIGS. 11-13.

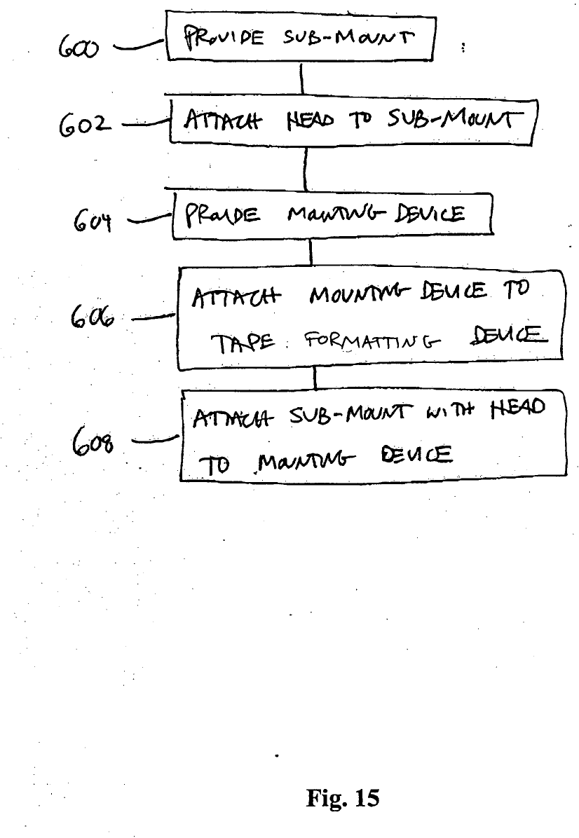

FIG. 15 illustrates an example of operations that may be performed in accordance with one embodiment of the present invention. At operation 600, a sub-mount is provided which permits the removable detachment of a head to a recording device, such as a tape formatting device for writing servo tracks onto a tape. The sub-mount may be made and shaped in various ways, such as shown in FIGS. 3, 4, 7, 8-11 and 12-14, and in one example, includes at least one surface for attachment to a head, and at least one surface for removable attachment to a mounting device. The sub-mount may also be provided with one or more mounting holes or slots that are adapted for engagement with a corresponding portion (i.e., pins) of a mounting device.

At operation 602, the head is attached to the sub-mount, and preferably the head is precisely positioned relative to the sub-mount and adhesive or other conventional securement methods may be used to attach the head to the sub-mount. At operation 604, a mounting device is provided which is adapted to be connected with a portion of the tape formatting device, and also provided to receive and releasably secure the sub-mount. In one example, the mounting device is provided with a receiving space or cavity that defines a surface and side walls which each or in combination may be used to securably receive the sub-mount, for example, as shown in FIG. 7 and FIGS. 9-10. In one example, at operation 604, one or more tape guiding surfaces may be provided on the mounting device.

At operation 606, the mounting device is attached to a recording device, such as a tape formatting device. Adjustments can be made to precisely position and orient the mounting device relative to the tape formatting device, for instance, so as to insure that the tape guiding surfaces are properly aligned with the expected position of the tape during use.

At operation 608, the sub-mount with the head attached thereto, is releasably attached to the mounting device. Through the use of the engagement surfaces between the sub-mount and the mounting device, the head is precisely positioned within the tape formatting device. Due to the removable nature of the sub-mount relative to the mounting device, the assembly of the sub-mount/head can be attached, detached and used within different tape formatting devices having the same or different mounting devices, so long as the mounting devices are configured to receive the particular sub-mount device.

A sub-mount made according to embodiments of the present invention makes it easier to modify any existing equipment used in testing or in production so that different recording heads may be attached thereto. The use of structures on single plane to mount the sub-mount to a mounting device facilitates transfer of mounting references from one system to another system which may permit use with existing machinery. Use of a sub-mount also allows spatial tolerances and locations to be set by a head manufacturer, thus minimizing the amount of mechanical adjustments necessary in the production environment. This reduces sources of error in writing servo onto a tape during production. The sub-mount may also help protect fragile heads.

One or more features of the present invention can be utilized with or to form different tape formatting devices, servo-track writing devices, data storage systems or tape decks. Embodiments of the present invention may be used with various different types of heads, including as examples but not limited to ferrite heads, ceramic heads, thin film heads, type I or II heads, or any other conventional head.

A magnetic tape may be manufactured by a method utilizing one or more features of the present invention. In one example, servo information is written onto a magnetic tape using a servo head mounted on a sub-mount that is removably attached to a mounting device. In one example, the method includes attaching the sub-mount to the mounting device along a plane of the sub-mount. The attaching operation may include providing, on the plane of the sub-mount, at least one a hole, pin, or other attachment mechanism.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

While the invention has been particularly shown and described with reference to a preferred embodiment thereof, it will be understood by those skilled in the art that various other changes in the form and details may be made without departing from the spirit and scope of the invention.

1. A magnetic recording head assembly for connecting a magnetic head to a tape formatting device, comprising:
a mounting device for attachment to the tape formatting device, the mounting device having a receiving cavity; and
a sub-mount for attaching the magnetic head to the mounting device, the sub-mount having a first end connected with the magnetic head and a second end removably connected with the mounting device within the receiving cavity.

2. The assembly of claim 1, wherein the mounting device includes a tape guiding structure for guiding a tape along the mounting device and over the magnetic head.

3. The assembly of claim 1, wherein the cavity of the mounting device is generally U-shaped.

4. The assembly of claim 1, wherein the mounting device includes at least one bore hole for positioning the mounting device relative to the tape formatting device.

5. The assembly of claim 1, wherein the sub-mount includes at least one surface for mating with at least one surface of the mounting device.

6. The assembly of claim 5, wherein the at least one surface of the sub-mount is a bottom surface and includes at least one pin receiving opening; and
wherein the at least one surface of the mounting device is a top surface engaging the bottom surface of the sub-mount and includes at least one pin for engagement with the at least one pin receiving opening of the sub-mount.

7. The assembly of claim 1, wherein the sub-mount has a central opening extending between the first end and the second end.

8. The assembly of claim 1, wherein the sub-mount has a recessed slot for housing a wire guide.

9. The assembly of claim 1, wherein the magnetic head is attached to the sub-mount by an adhesive.

10. The assembly of claim 1, wherein the magnetic head is attached to the sub-mount at an offset from a center of the sub-mount.

11. The assembly of claim 1, wherein the magnetic head is a ferrite head.

12. A method of mounting a head to a tape formatting device, comprising:
providing a sub-mount;
providing a mounting device;
attaching the head to the sub-mount; and
attaching the sub-mount to the mounting device.

13. The method of claim 12, further comprising: attaching the mounting device to the tape formatting device.

14. The method of claim 12, wherein the operation of attaching the head to the sub-mount is performed in accordance with a predetermined spatial relationship.

15. A magnetic tape manufactured by a method comprising:
writing servo information onto the magnetic tape using a servo head mounted on a sub-mount that is removably attached to a mounting device.

16. The method of claim 15, further comprising:
attaching the sub-mount to the mounting device along a plane of the sub-mount.

17. The method of claim 16, wherein the attaching operation includes:
providing, on the plane of the sub-mount, at least one a hole.

18. The method of claim 16, wherein the attaching operation includes:
providing, on the plane of the sub-mount, at least one a pin.

19. An apparatus for coupling a magnetic head to a mounting device of a tape formatting device, comprising:
an elongated body having a first end for connection with the magnetic head and a second end for removable connection with the mounting device.

20. The apparatus of claim 19, wherein the elongated body includes at least one surface for mating with at least one surface of the mounting device.

21. The apparatus of claim 20, wherein the at least one surface of the elongated body is a bottom surface and includes at least one pin receiving opening; and
wherein the at least one surface of the mounting device is a top surface engaging the bottom surface of the elongated body includes at least one pin for engagement with the at least one pin receiving opening.

22. The apparatus of claim 19, wherein the elongated body has a central opening extending between the first end and the second end.

23. The apparatus of claim 19, wherein the elongated body has a recessed slot for housing a wire guide.

24. A tape formatting device for writing servo tracks onto a magnetic tape, comprising:
a magnetic head;
a mounting device for attachment to the tape formatting device, the mounting device having a receiving cavity; and
a sub-mount for attaching the magnetic head to the mounting device, the sub-mount having a first end connected with the magnetic head and a second end removably connected with the mounting device.
